(19) United States
(12) Patent Application Publication
(10) Pub. No.: US 2011/0194495 A1
(43) Pub. Date: Aug. 11, 2011

(54) Method for Managing Radio Resources for Uplink and Downlink in Wireless Communication System

(76) Inventors: Han Byul Seo, Gyeongki-do (KR); Byoung Hoon Kim, Gyeongki-do (KR)

(21) Appl. No.: 13/063,401

(22) PCT Filed: Jul. 14, 2009
(86) PCT No.: PCT/KR09/03849

§ 371 Date: Mar. 10, 2011

Related U.S. Application Data
(60) Provisional application No. 61/099,897, filed on Sep. 24, 2008.

(30) Foreign Application Priority Data
Nov. 3, 2008 (KR) 10-2008-0108207
Jun. 9, 2009 (KR) 10-2009-0050874

(51) Int. Cl. H04W 72/00

(52) U.S. Cl. 370/328

(57) ABSTRACT

A method for managing radio resources for an uplink and a downlink in a wireless communication system is provided. The method for managing radio resources may be applied to a system based on a heterogeneous cell deployment scenario. The heterogeneous cell deployment scenario implies that a plurality of cells coexist in the wireless communication system, and transmit power, processing capacity, and/or cell coverage are different from one cell to another. In the method for managing radio resources, a mobile station included in the wireless communication system establishes an uplink and a downlink with the same base station. In addition, an asymmetric management scheme is used in which a radio resource management scheme used for the uplink is different from a radio resource management scheme used for the downlink. Accordingly, each mobile station can use a different optimal radio resource management scheme for the uplink and the downlink, each mobile station and link can be effectively controlled, and usage efficiency of radio resources can be improved.

### TECHNICAL FIELD

The present invention relates to wireless communications, and more particularly, to a method for managing radio resources for an uplink (UL) and a downlink (DL) in a wireless communication system.

### BACKGROUND ART

Wireless communication systems are widely used to provide various types of communications. For example, voice and/or data service are provided by the wireless communication systems. Conventionally, a wireless communication system provides multiple users with one or more shared resources. For example, the wireless communication system can use various multiple access schemes such as code division multiple access (CDMA), time division multiple access (TDMA), frequency division multiple access (FDMA) and orthogonal frequency division multiple access (OFDMA).

Orthogonal frequency division multiplexing (OFDM) uses a plurality of orthogonal subcarriers. The OFDM uses an orthogonality between inverse fast Fourier transform (IFFT) and fast Fourier transform (FFT). A transmitter transmits data by performing IFFT. A receiver restores original data by performing FFT on a received signal. The transmitter uses IFFT to combine the plurality of subcarriers, and the receiver uses corresponding FFT to split the plurality of subcarriers. According to the OFDM, complexity of the receiver can be reduced in a frequency selective fading environment of a broadband channel, and spectral efficiency can be increased when selective scheduling is performed in a frequency domain by using a channel characteristic which is different from one subcarrier to another. Orthogonal frequency division multiple access (OFDMA) is an OFDM-based multiple access scheme. According to the OFDMA, efficiency of radio resources can be increased by allocating different subcarriers to multiple users.

For effective system configuration, the wireless communication system has a cell structure. A cell is a zone in which a wide area is divided into small areas for effective frequency use. In general, a multiple-access system includes multiple cells. A base station (BS) is generally installed within the cell to transmit and receive a signal with a mobile station (MS).

The wireless communication system supports a downlink (DL) and an uplink (UL) to support a full duplex communication via a radio interface. The DL is a communication link from the BS to the MS, and the UL is a communication link from the MS to the BS. The BS (e.g., node-B) manages the cell, and a scheduler located in the BS determines a specific MS for which data is transmitted within the cell. The MS may be a mobile or fixed apparatus operated by a user while walking or driving.

When a plurality of MSs exists within a cell, the plurality of MSs can simultaneously transmit or receive data. Interference may occur in this case. The interference may occur by thermal noise, power transmitted from another cell, dedicated-channel power transmitted within the cell, common-channel power transmitted within the cell, etc.

In the wireless communication system, radio resources are allocated based on a certain rule. The radio resources allocated in UL are UL resources. The radio resources allocated in DL are DL resources. In the DL, the BS reports the DL resources via which a data stream is carried to the MS, and the MS receives the data stream via the DL resources. In the UL, the BS reports the allocated UL resources to the MS, and the MS transmits the data stream via the UL resources.

A conventional method for managing radio resources includes UL resource allocation and DL resource allocation under the premise that each cell constituting a wireless network has almost similar transmit power, cell coverage, etc., which will be referred hereinafter as a ‘homogeneous cell deployment scenario’ or a ‘homogeneous scenario’. When the homogeneous scenario is assumed, properties such as an inter-cell interference property of an MS located in a specific position, a signal to interference plus noise ratio (SINR) property, or the like, are similar in the UL and the DL. Therefore, in the perspective of the MS, selecting of an optimal BS for the DL can be the same as selecting of an optimal BS for the UL. For this reason, in a conventional wireless communication system based on the homogeneous scenario, a strength of a DL signal has generally been considered as a criterion by which an MS selects a BS that provides a service to the MS.

In the conventional wireless communication system based on the homogeneous scenario, optimal radio resource management schemes (e.g., a power control scheme, a frequency reuse scheme, and/or a multi-cell cooperation scheme, etc.) in use are identical for the UL and the DL. Accordingly, even if a symmetric radio resource management scheme is used for the UL and the DL in the convention wireless communication system, radio resources can be effectively managed to more than a certain extent.

In the symmetric radio resource management scheme, radio resource management schemes including power control, frequency reuse, and/or multi-cell cooperation are identical for the UL and the DL. For example, assume that an MS is located at a cell boundary and thus DL received power is low. In this case, according to the symmetric radio resource management scheme, a high frequency reuse factor is applied to the MS, and frequency bands which neighboring cells do not use are assigned to the MS for both the UL and the DL, thereby avoiding inter-cell interference.

Meanwhile, a micro cell or a pico cell, a home e-node-B (HeNB), and/or a relay station (RS), etc., are expected to be emerged as main constitutional elements of a next generation wireless network. If such constitutional elements coexist with a legacy macro cell, transmit power of each cell, processing capacity of the BS, and the service coverage of each cell may be significantly different from one cell to another according to presence/absence of the constitutional elements, performance, capacity, etc., which will be described hereinafter as a ‘heterogeneous cell deployment scenario’ or a ‘heterogeneous scenario’. In a wireless communication system based on the heterogeneous scenario, the inter-cell interference property, the SINR property, etc., of the MS located in a specific position may be different in the UL and the DL. A main reason for this is because transmit power of a BS managing the macro cell is significantly higher than transmit power of the aforementioned other constitutional elements (e.g., a relay station (RS) or a BS managing the micro cell or the pico cell).

FIG. 1 is a diagram for explaining a communication feature in a wireless communication system based on the heterogeneous scenario. As an example of the wireless communication system based on the heterogeneous scenario, FIG. 1 shows a case where two BSs have different transmit power (i.e., transmit power of a first BS (BS1) is lower than that of a second BS (BS 2)). In addition, in FIG. 1, a first MS (MS1) is located near the first BS having relatively lower transmit power, a third MS (MS 3) is located near the second BS having relatively high transmit power, and a second MS (MS 2) is located in a cell boundary region between the first BS and the second BS.

Referring to FIG. 1, regarding the first MS, DL received power is higher in the first BS. Further, regarding the second MS, the DL received power is higher in the second BS. On the other hand, regarding both the first MS and the second MS, UL path loss is higher in the second BS than the first BS. In this case, if a BS needs to be selected according to the conventional method, the first MS selects the first BS and the second MS selects the second BS not only for the DL but also for the UL. However, from the perspective of the UL, it is preferable for the second MS to perform communication with the first BS that can generate a signal having a largest strength due to a small path loss. Therefore, in the wireless communication system based on the heterogeneous scenario, regarding a specific MS, an optimal BS for the UL may be different from an optimal BS for the DL.

To solve the problem in that an optimal BS may be different for the UL and the DL in the wireless communication system based on the heterogeneous scenario, a method is proposed in which different BSs are assigned in the UL and the DL for a specific MS (i.e., the second MS in FIG. 1). This method is effective to a certain extent from an aspect that an optimal BS for each link can be connected to the specific MS. However, the method has a problem in that, when the UL and the DL for the MS are established with different BSs, a DL channel that controls and manages a specific link (e.g., UL) may be separated from a UL channel through which actual data is transmitted.

More specifically, in the aforementioned example of FIG. 1, it is assumed that, by considering strength of a received signal, the second BS is assigned as a BS for the DL of the second MS, and the first BS is assigned as a BS for the UL of the second MS. In this case, data transmitted by the second MS is received by the first BS, whereas a signal for controlling and managing a UL channel between the second MS and the first BS is transmitted by the second BS to the second MS. Therefore, a BS that receives information (i.e., a variety of information including not only UL data but also a channel state, etc.) for management and control of the UL channel and provided by the MS is different from a BS that transmits a signal (e.g., UL scheduling information) for UL control and management and to be provided to the MS.

To solve such a problem, a method is considered in which the signal for UL control and management is transmitted by a BS (e.g., the first BS) with which the UL of an MS (e.g., the second MS) is established. However, in this case, the signal for control and management is transmitted through the DL which is not optimized to transmit a DL signal, resulting in waste of radio resources. Further, there is a difficult problem in that a transmission time has to be properly scheduled so that collision or interference does not occur between the DL signal for control and management and UL data transmitted through the DL. In addition, if an MS (e.g., the second MS) moves its location and performs a handoff to another BS, two BSs (e.g., the first BS and the second BS) have to participate in a handoff procedure. As a result, a problem may occur in which an amount of signal for the handoff is increased, and a time for performing the handoff is also increased.

### DISCLOSURE OF INVENTION

### Technical Problem

The present invention provides a method for effectively managing radio resources for an uplink (UL) and a downlink (DL) in a wireless communication system based on a heterogeneous scenario.

The present invention also provides a method for managing radio resources to easily manage a mobile station and a channel, to minimize waste of the radio resources for a UL and a DL, and to improve data throughput in a wireless communication system based on a heterogeneous scenario.

### Solution to Problem

To solve the aforementioned problems, the present invention provides a method for managing radio resources in a wireless communication system. According to an aspect of the present invention, the wireless communication system is based on a heterogeneous cell deployment scenario. In addition, a mobile station included in the wireless communication system establishes an uplink and a downlink with the same base station. In addition, a radio resource management scheme used for the uplink is different from a radio resource management scheme used for the downlink.

For example, the radio resource management scheme may include a frequency reuse scheme. In the frequency reuse scheme, a frequency reuse factor for the downlink may use a relatively low value, and a frequency reuse factor for the uplink may use a relatively high value. In addition, the wireless communication system may include first and second neighboring cells each having different cell coverage, and a frequency used in the uplink by the first cell having smaller cell coverage than the second cell may be used in the uplink of a mobile station separated far from the first cell and belonging to the coverage of the second cell. Alternatively, the wireless communication system may include at least one second cell having relatively small coverage inside or at a boundary region of the first cell having relatively large coverage, and a frequency for uplink transmission of the mobile station connected to a base station of the first cell may be different in an interference area of the second cell and a non-interference area of the second cell.

In addition, the radio resource management scheme may include a multi-cell cooperative communication scheme. In this case, a downlink signal may be transmitted from one base station, and an uplink signal may be received by a plurality of base stations for multi-cell cooperation communication. Alternatively, a downlink signal may be transmitted from a plurality of base stations performing multi-cell cooperation communication, and an uplink signal may be received by only one base station. In addition, channel information on the downlink may be not exchanged between base stations for multi-cell cooperation communication, and channel information on the uplink may be exchanged between the base stations for multi-cell cooperation communication. Alternatively, channel information on the uplink may be not exchanged between base stations for multi-cell cooperation communication, and channel information on the downlink may be exchanged between the base stations for multi-cell cooperation communication.

In addition, the radio resource may be time resource or frequency resource.

### Advantageous Effects of Invention

According to embodiments of the present invention, different radio resource management schemes are used in an uplink and a downlink in a wireless communication system based on a heterogeneous scenario where a plurality of cells coexist and transmit power, processing capacity, and/or cell coverage are different from one cell to another. Therefore, data throughput of each mobile station can be improved, and usage efficiency of radio resources can be improved. In addition, since all mobile stations establish the uplink and the downlink with the same base station, channels and the mobile stations can be effectively controlled, and efficiency of radio resources of each link can be maximized.

### BRIEF DESCRIPTION OF DRAWINGS

FIG. 1 is a diagram for explaining a communication feature in a wireless communication system in which two base stations have different transmit power.

FIG. 2 is a diagram showing an example of a wireless communication system according to an embodiment of the present invention.

FIG. 3 is a diagram showing a frequency reuse scheme according to an embodiment of the present invention.

FIG. 4 is a diagram showing a time reuse scheme according to an embodiment of the present invention.

FIG. 5 is a diagram showing a semi frequency reuse scheme in the wireless communication system of FIG. 1 and FIG. 2 according to an embodiment of the present invention.

FIG. 6 is a diagram showing a semi time reuse scheme in the wireless communication system of FIG. 1 and FIG. 2 according to an embodiment of the present invention.

FIG. 7 is a diagram for explaining a semi resource reuse scheme according to an embodiment of the present invention.

FIG. 8 is a diagram showing an example of a resource allocation scheme for UL transmission of MSs connected to the BS of the macro cell of FIG. 7.

FIG. 9 and FIG. 10 are diagrams for explaining a semi frequency reuse scheme according to another embodiment of the present invention.

FIG. 11 is a flowchart showing a resource allocating method according to an embodiment of this invention.

FIG. 12 is a flowchart showing a resource allocating method of a macro cell according to another embodiment of this invention.

### MODE FOR THE INVENTION

Hereinafter, exemplary embodiments of the present invention will be described in detail with reference to the accompanying drawings.

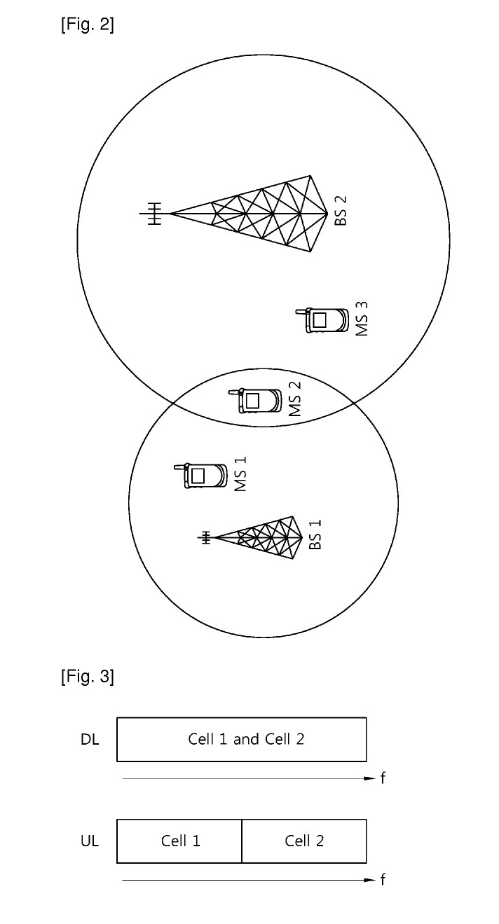

FIG. 2 is a diagram showing an example of a wireless communication system according to an embodiment of the present invention. The wireless communication system can be widely deployed to provide a variety of communication services, such as voices, packet data, etc. Referring to FIG. 2, the wireless communication system includes one or more mobile stations (MS1, MS2, MS3) and one or more base stations (BS1, BS2).

The MS may be fixed or mobile, and may be referred to as another terminology, such as a user equipment (UE), a user terminal (UT), a subscriber station (SS), a wireless device (or wireless station), etc. In FIG. 2, a first MS (MS1) is located within the cell coverage of a first BS (BS1). A third MS (MS3) is located with the cell coverage of a second BS (BS2). A second MS (MS2) is located at a cell boundary. The locations of the MSs are for exemplary purposes only. In the wireless communication system according to the embodiment of the present invention, some MSs (e.g., the first MS (MS1) and the third MS (MS3)) have the same optimal BS for an uplink (UL) and a downlink (UL), but other MSs (e.g., the second MS (MS2)) may have different optimal BSs for the UL and the DL.

The MSs include at least a transceiver and a processor. The transceiver is an entity for allowing the MS to transmit and receive a variety of signals and data (e.g., UL signals and DL signals) through a wireless network such as a mobile communication network. The processor controls an operation of the MS. Further, the processor generates a UL signal to be transmitted through the transceiver, or reads a received DL signal.

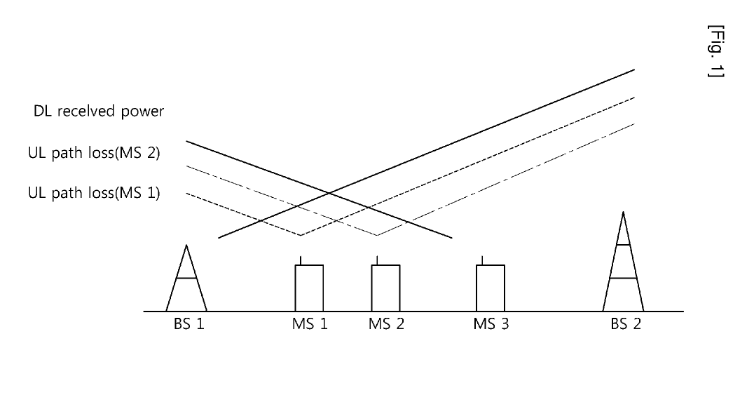

The BS is generally a fixed station that communicates with the MS and may be referred to as another terminology, such as a node-B, a base transceiver system (BTS), an access point, etc. There are one or more cells within the coverage of the BS 20. In FIG. 2, the BS2 is larger than the BS1 to show that transmit power of the BS2 is greater than that of the BS1 as shown in FIG. 1, but this is for exemplary purposes only.

An embodiment of the present invention described below can be applied to various wireless communication systems.

For example, the embodiment of the present invention can be applied to not only a communication system having a plurality of transmit antennas but also a communication system having one transmit antenna. The wireless communication system may be not only a multiple input multiple output (MIMO) system or a multiple input single output (MISO) system but also a single input single output (SISO) system or a single input multiple output (SIMO) system. In addition, the embodiment of the present invention can be used irrespective of a channel coding scheme of the wireless communication system. Various well-known schemes such as convolution coding, turbot coding, etc., can be used as the channel coding scheme.

Further, the embodiment of the present invention described below can also be applied to a wireless communication system including a relay station (RS). In the wireless communication system including the RS, MSs existing within the coverage of a BS may directly communicate with the BS and/or may communicate with the BS via one or more RSs. A wireless communication system performing communication in cooperation of a plurality of RSs is referred to as a cooperative (or coordinated) wireless communication system based on multiple RSs. The embodiment of the present invention described below can also be applied to the cooperative wireless communication system based on multiple RSs.

Furthermore, the embodiment of the present invention described below can also be applied to not only a wireless communication system consisting of only a macro cell but also a wireless communication system including constitutional elements such as a micro cell or a pico cell, a home e-node-B (HeNB), an RS, etc. In the latter case, a station (i.e., a type of a BS) for the micro cell or the pico cell, the HeNB, or the RS may exist at any location within the cell coverage of the BS or may exist outside the cell coverage of the BS. In particular, the embodiment of the present invention described below can be usefully applied to a case where some MSs have different optimal BSs for the UL and the DL when the micro cell or the pico cell exists within the macro cell or when the HeNB or the RS is present.

The wireless communication system is a system based on a heterogeneous cell deployment scenario. The system based on the heterogeneous cell deployment scenario (or heterogeneous scenario) implies a system in which a plurality of cells coexist, and transmit power of a BS controlling each cell, processing capacity of each cell, and/or cell coverage are different from one cell to another.

Hereinafter, a method for managing radio resources for an UL and a DL will be described. An embodiment of the present invention is described based on the wireless communication system of FIG. 2. Cell coverage of a BS2 cell is relatively larger than that of a BS1 cell. A macro cell is a cell whose coverage is relatively large such as the BS2. A micro cell is a cell whose cell coverage is relatively small such as the BS1. DL transmit power of the micro cell is weaker than DL transmit power of the macro cell. In this specification, the micro cell may mean a femto cell, a pico cell, a HeNB, a RS as well as a micro cell.

In the method for management radio resources according to the embodiment of the present invention, a wireless communication system is based on the heterogeneous scenario where transmit power, processing capacity, and/or cell coverage are different from one cell to another. In such a wireless communication system, each MS establishes the UL and the DL with the same BS. Not only the MS1 and MS3 having the same optimal BS for the UL and the DL but also the MS2 having different optimal BSs for the UL and the DL establish the UL and the DL with the same BS. As such, when both the UL and the DL are established with the same BS, the MSs or data channels can be easily managed.

There is no restriction on a method for selecting a BS to which the UL and the DL are established. Thus, any conventional schemes used in this technical field can be used. For example, the MS can establish both the UL and the DL with a BS having greatest DL signal strength. In this case, as shown in the example of FIG. 2, the MS1 establishes the UL and the DL with the BS1, whereas the MS2 and the MS3 establish the UL and the DL with the BS2.

According to another embodiment of the present invention, a method for managing radio resources uses an asymmetric management scheme in which different types of radio resource management schemes are applied in both links to consider heterogeneous features of the UL and the DL. More specifically, according to this embodiment of the present invention, a radio resource management scheme (e.g., a time or frequency reuse scheme, a multi-cell cooperative communication scheme, etc.) can be differently applied in the UL and the DL. In addition, a semi resource reuse scheme can also be used as the asymmetric management scheme. The semi resource reuse scheme implies that a BS of the macro cell does not use some of time or frequency resources in a region near a BS of the micro cell but allocates the time or frequency resources to MSs located far from the BS of the micro cell.

The necessity of using the asymmetric management scheme will be described in detail with reference to the wireless communication system of FIG. 1 and FIG. 2 according to an embodiment of the present invention.

First, in the wireless communication system of FIG. 1 and FIG. 2 according to the embodiment of the present invention, each MS establishes both a UL and a DL with a BS having strongest DL signal strength. As a result, the MS1 establishes the UL and the DL with the BS1, and the MS2 and the MS3 establish the UL and the DL with the BS2. In this case, in the DL of all MSs, a BS connected to a corresponding MS has strongest signal strength, and thus the conventional method can be directly used for DL radio resources.

On the other hand, for UL radio resources, the conventional method cannot be used directly, and thus another method is required. This is because the MS2 is located closer to the BS1 not connected with the MS2 than the BS2 connected with the MS2. Therefore, if the UL radio resources are managed using a method similar to the conventional method, the MS2 has to use high transmit power to communicate with the BS2 which is farther in distance. As a result, severe interference may occur in the UL through which the MS1 communicates with the BS1.

Therefore, in the wireless communication system which is based on the heterogeneous scenario and in which MSs establish the UL and the DL with the same BS, a special management scheme is not additionally required in the DL. However, the special management schemes need to be introduced in the UL to prevent interference occurring in UL communication between neighboring MSs and neighboring BSs. That is, in the method of managing radio resources according to the embodiment of the present invention, the radio resources need to be managed asymmetrically for the UL and the DL.

Hereinafter, the method of managing radio resources in the wireless communication system of FIG. 1 and FIG. 2 according to the embodiment of the present invention will be described in detail from the perspective of resource reuse, multi-cell cooperative communication, and semi resource reuse. The resource may be time resource or frequency resource.

Frequency Reuse

When data is transmitted in the same cell by a plurality of MSs, orthogonal multiplexing may be performed to avoid intra-cell interference. On the other hand, when data is transmitted in different cells, orthogonality may not be guaranteed, and the MSs may experience inter-cell interference from another cell. For example, in an orthogonal frequency division multiplexing (OFDM)-based wireless communication system, a whole system bandwidth is partitioned into a plurality of orthogonal subcarriers, and data is carried and transmitted on the subcarriers. If a system uses a plurality of carriers similarly to the case of using OFDM in a multi-cell environment, users may experience interference when neighboring cells use the same subcarrier.

In order to maximize a data transfer rate, it is preferable to minimize interference acting on an MS. As one scheme for reducing inter-cell interference, different frequencies may be used between cells. This is called frequency reuse. For example, if the number of neighboring cells (or frequency reuse factors) is 3, a full frequency band is divided into 3 parts so that the divided parts do not overlap between the cells, thereby avoiding the inter-cell interference. However, this results in deterioration of whole spectrum efficiency. Alternatively, a directional antenna may be deployed so that a signal from a specific cell does not overlap with a signal from another cell. However, interference still exists for an MS located in a cell boundary.

FIG. 3 is a diagram showing a frequency reuse scheme according to an embodiment of the present invention. In the present embodiment, BSs use different frequency reuse schemes, and each BS can apply its frequency reuse scheme differently in a UL and a DL.

Referring to FIG. 3, in the frequency reuse scheme according to the embodiment of the present invention, each of a first cell (cell 1) and a second cell (cell 2) uses a whole band in a DL channel without additional frequency reuse (i.e., a frequency reuse factor is 1). On the other hand, a frequency band used in a UL channel by the cell 1 and the cell 2 is properly divided while avoiding overlapping (e.g., the frequency reuse factor may be 3 greater than 1). As an example of a method for dividing the frequency band while avoiding overlapping, as shown in FIG. 3, the full frequency band is divided by half for the cell 1 and the cell 2. As an example of FIG. 1 and FIG. 2, if the MS2 transmits a UL signal to the BS2, the MS2 does not use a frequency band which the MS1 uses to transmit a UL signal. Accordingly, interference (i.e., inter-cell interference) can be prevented from occurring in UL communication between the BS1 and another MS (e.g., the MS1) when the MS2 transmits a UL signal with relatively high transmit power.

According to another embodiment of the present invention, for adaptive frequency reuse, the frequency reuse scheme uses a location or a moving speed of an MS, a characteristic of the MS (i.e., whether an optimal BS for the UL is identical to an optimal BS for the DL). In this embodiment, under the premise that a BS can apply the frequency reuse scheme differently for the UL and the DL, a symmetric radio resource management scheme (i.e., conventional method) is used for some of MSs connected to the BS, and an asymmetric radio resource management scheme is applied to the remaining MSs, which will be described below in detail.

First, all MSs establish not only a DL but also a UL to a BS having highest DL signal strength. Regarding an MS having the same optimal BS for the UL and the DL, similarly to the conventional method, frequencies are reused in the same manner in both the UL and the DL (i.e., symmetrical radio resource management scheme). For example, in the aforementioned example, regarding the MS1, radio resources are managed such that frequencies are reused in the same manner in both the UL and the DL. In this case, for the MS1, the frequency reuse factor is set to a low value (e.g., ‘1’), so that the full frequency band can be used in both the UL and the DL as widely as possible.

On the other hand, regarding an MS having different optimal BSs for the UL and the DL (e.g., an MS located in a boundary of a micro cell and a macro cell), unlike the conventional method, frequencies are reused differently in the UL and the DL (i.e., asymmetrical radio resource management scheme). For example, in the aforementioned example, regarding the MS2, radio resources are managed such that frequencies are reused in a different manner in the UL and the DL. In this case, for the MS2, the frequency reuse factor is set to a low value (e.g., ‘1’) for the DL so that the frequency band can be used as widely as possible, and the frequency reuse factor is set to a high value (e.g., ‘3’ or ‘7’) for the UL so that interference does not occur in UL communication of neighboring cells.

Aforementioned frequency reuse scheme may be also applied to a time reuse scheme.

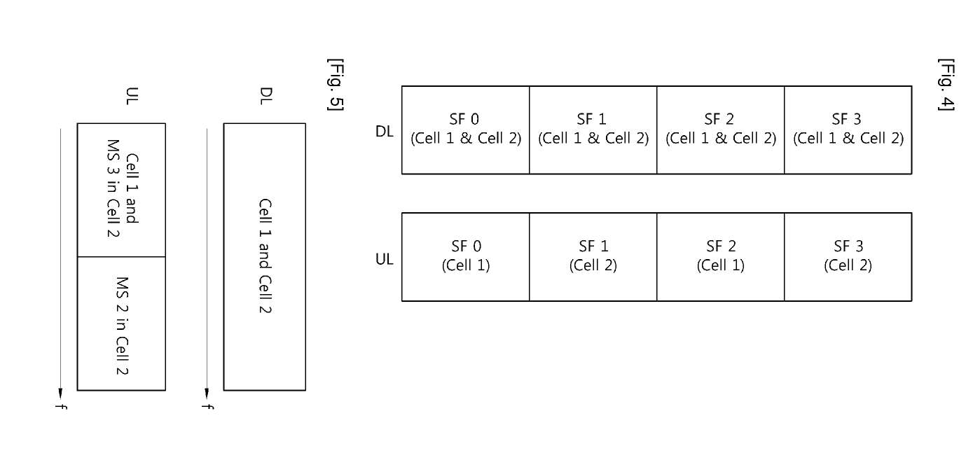

FIG. 4 is a diagram showing a time reuse scheme according to an embodiment of the present invention. In this embodiment, the time reuse scheme is differently applied according to cells. Each cell can differently apply the time reuse scheme for UL and DL. Time resources can be expressed as subframes, time slots, OFDMA (Orthogonal Frequency Division Multiple Access) symbols, etc.

Referring to FIG. 4, each of a first cell (cell 1) and a second cell (cell 2) uses a whole time resource in a DL channel without additional time reuse. On the other hand, a time resource used in a UL channel by the cell 1 and the cell 2 is properly divided while avoiding overlapping. The cell 1 may be a micro cell, and the cell 2 may be a macro cell. FIG. 4 is an example of a method for dividing the time resource while avoiding overlapping. It is showed that each subframe is assigned one after the other for the cell 1 and cell 2 as the time resource for the UL transmission. That is, even subframes are assigned for the cell 1, and odd subframes are assigned for the cell 2. Accordingly, interference can be prevented from occurring in UL communication between the BS1 and another MS (e.g., the MS1) when the MS2 transmits a UL signal with relatively high transmit power.

A resource reuse method between neighboring heterogeneous cells according to an embodiment of this invention is not limited as aforementioned, and it is performed variously.

Semi Frequency Reuse

It is assumed that UL frequencies for the cell 1 and the cell 2 are divided in the whole frequency band as shown in FIG. 3. In this case, in principle, a UL frequency band used by the MS1 is not used by an MS (e.g., the MS2) connected to the BS2. However, although a frequency band in a range assigned to the cell 1 is used by the MS3, there is almost no possibility of interference in communication between the BS1 and the MS1. This is because the MS3 is separated far from the BS1 even if the MS3 is connected to the BS2. By managing radio resources in this manner, even if frequencies used by the cell 2 and its neighboring cell 1 are partially different, the cell 2 can use the full frequency band when considering a full coverage. Such a frequency reuse is referred to as a ‘semi frequency reuse’ in the present invention.

According to the semi frequency reuse scheme, a low frequency reuse factor is applied in the DL irrespective of a size of cell coverage (or a transmit power level of a BS). On the other hand, in the UL, the frequency reuse scheme varies depending on the size of the cell coverage between neighboring cells. For example, regarding the cell 1 that is a micro cell among neighboring cells, a high frequency reuse factor is applied. That is, the cell 1 is allowed to use only some frequencies of the full frequency band.

On the other hand, regarding the cell 2 that is a macro cell, MSs separated far from a BS of the cell 1 are assigned with frequencies in the same range as a frequency used by the cell 1, and the MSs that is located on a boundary of the cell 1 are assigned with frequencies in a different range of the frequency used by the cell 1. That is, radio resources are managed in such a manner that the cell 2 has a high frequency reuse factor partially but has a low frequency reuse factor as a whole. When UL radio resources are managed in this manner, an MS separated far from the BS of the cell 1 can use power control, beamforming, etc., so that a UL signal of the MS can be satisfactorily received by a BS connected to the MS while avoiding or reducing interference in neighboring BSs.

FIG. 5 is a diagram showing a semi frequency reuse scheme in the wireless communication system of FIG. 1 and FIG. 2 according to an embodiment of the present invention. Referring to FIG. 5, in the DL, the frequency reuse factor is 1, and thus each of a cell 1 and a cell 2 use the full frequency bandwidth. On the other hand, in the UL, radio resources are managed in such a manner that the cell 1 and the cell 2 basically use distinctive frequencies in the full frequency band, but a UL frequency used by the MS3 overlaps with a frequency used by the cell 1.

The semi frequency reuse scheme according to the embodiment of the present invention can be extensively used for a case where one or more micro cells exist inside and/or adjacent to a macro cell. When several micro cells are located adjacent to and/or inside a macro cell, a frequency region assigned for UL transmission of MSs, which are located in a boundary of each micro cell and which are connected to a BS of the macro cell, has to be different from a frequency assigned for each of one or more micro cells neighboring to each MS.

Aforementioned semi frequency reuse scheme is also applied to a semi time reuse scheme.

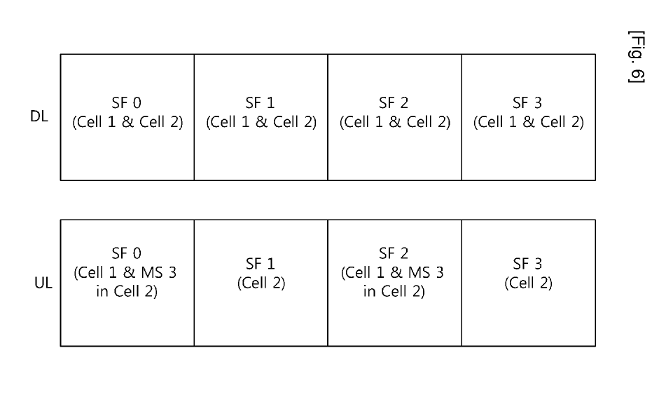

FIG. 6 is a diagram showing a semi time reuse scheme in the wireless communication system of FIG. 1 and FIG. 2 according to an embodiment of the present invention.

Referring to FIG. 6, each of a cell 1 and a cell 2 uses a whole time region for a DL transmission. On the other hand, a MS1 of the cell 1 and a MS2 of the cell 2 use different subframes for a UL transmission. For example, the MS1 transmits UL via even subframes, and the MS2 transmits UL via odd subframes. However, a MS 3 that is located far from a boundary of the cell 1 transmits UL via subframes used by the MS1. Accordingly, in UL transmission, a micro cell uses a part of whole time region, and a macro cell uses whole time region.

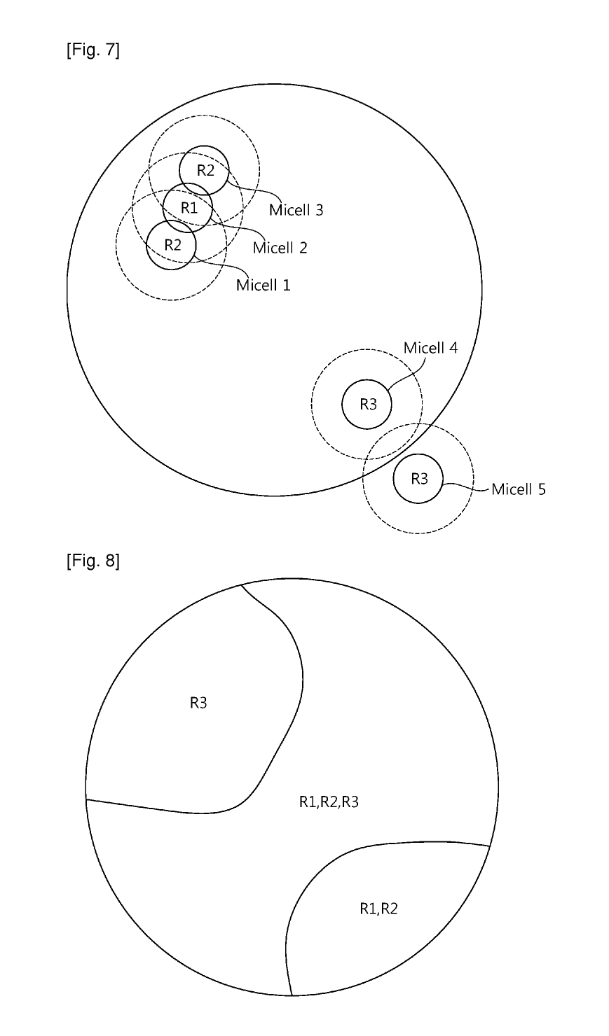

FIG. 7 is a diagram for explaining a semi resource reuse scheme according to an embodiment of the present invention. In an example of FIG. 7, three micro cells (micro cell 1 (Micell 1), micro cell 2 (Micell 2), and micro cell 3 (Micell 3)) exist within a macro cell (Macell). In addition, two micro cells (Micell 4, Micell 5) exist in a boundary region of the macro cell. Each circle indicated by a solid line in FIG. 7 represents an area of each of the cells. Each area indicated by a dotted line represents an interference area where inter-cell interference may occur caused by UL signals of each of the micro cells.

Referring to FIG. 7, MSs located inside solid-lined circles of the micro cells (Micell 1˜Micell 5) transmit UL signals by using corresponding resources R1, R2, and R3. The resources may be time resources (T1, T2, T3) or frequency resources (F1, F2, F3). For example, MSs located within a coverage range of the micro cells 1 or 3, and connected to a BS of the micro cell 1 or 3 transmit UL signals by using the second resource R2, and MSs located within a coverage range of the micro cell 2, and connected to a BS of the micro cell 2 transmit UL signals by using the first resource R1. Further, MSs located within a coverage range of the micro cells 4 or 5, and connected to a BS of the micro cell 4 or 5 transmit UL signals by using the third resource R3. In this case, cells (e.g., the micro cell 1 and the micro cell 2, the micro cell 2 and the micro cell 3) having an overlapping coverage use different resource to avoid inter-cell interference. Further, micro cells located far from each other, such as the micro cells 1 to 3 and the micro cells 4 to 5, may be configured to receiver UL signals by using different resource. In this case, amount of resource which can be used for the macro cell MSs near each micro cell to communicate with the macro cell through the semi radio resource reuse may be increased.

Regarding MSs located in interference areas (i.e., an area inside the dotted-lined circle and outside the solid-lined circle) of the micro cell cells and connected to a BS of the macro cell, a resource region used by one or more micro cells cannot be used, and resource regions other than that resource region can be used as a resource region for UL transmission. For example, regarding MSs located in the interference area of the micro cell 2 using the first resource R1 and connected to the BS of the macro cell, resource (e.g., R2 or R3) other than the first resource R1 can be used as a resource for transmitting UL signals.

Regarding MSs located outside the interference areas (i.e., the area inside the dotted-lined circle and outside the solid-lined circle) of the micro cells and connected to the BS of the macro cell, all or some of resource used in one or more micro cells can be used as a resource for UL transmission. For example, regarding MSs located outside the interference areas of the micro cells 1 to 5, all or some of the first to third resource R1 to R3 can be used to transmit UL signals.

FIG. 8 is a diagram showing an example of a resource allocation scheme for UL transmission of MSs connected to the BS of the macro cell of FIG. 7. The resource may be time resource or frequency resource. Referring to FIG. 8, the third resource R3 may be assigned to MSs located in an area adjacent to the micro cells 1 to 3 using the first and second resource R1 and R2 and connected to the BS of the macro cell. The first resource R1 and/or the second resource R2 may be assigned to MSs located in an area adjacent to the micro cells 4 and 5 using the third resource R3 and connected to the BS of the macro cell. The first resource R1, the second resource R2, and/or the third resource R3 may be assigned to MSs located in the remaining areas and connected to the BS of the macro cell.

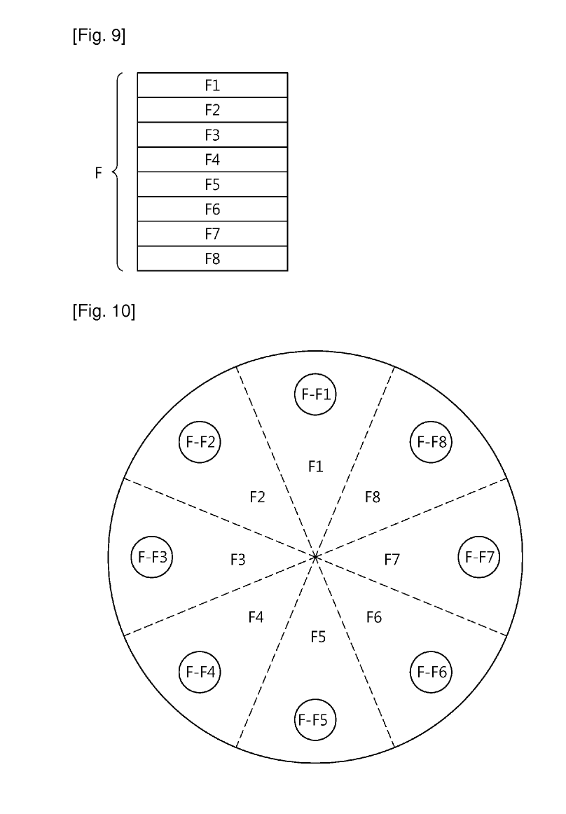

FIG. 9 and FIG. 10 are diagrams for explaining a semi frequency reuse scheme according to another embodiment of the present invention.

Referring to FIG. 9, a whole frequency bandwidth F is divided into several sub-bandwidth (F1˜F8). Referring to FIG. 10, a whole area means a macro cell, and the whole area is divided into several subarea (subarea 1˜subarea 8) according to locations of micro cells. MSs connected to a BS of the macro cell transmit UL signals via each frequency bandwidth according to each subarea in which the MS are located. For example, MSs located in subarea 1 and connected to the BS of the macro cell transmit UL signals via frequency F1. MSs located in subarea 2 and connected to the BS of the macro cell transmit UL signals via frequency F2. MSs connected to the micro cell of each subarea transmit UL signal via frequency bandwidth not to be used by MSs connected to the macro cell and located in the corresponding subarea. For example, MSs connected to the micro cell of the subarea 1 transmit UL signals via frequency bandwidth (F2˜F8) except frequency bandwidth F1 among the whole frequency bandwidth F. Accordingly, in UL transmission, the macro cell can use the whole frequency bandwidth (F1˜F8), and each micro cell can use remaining frequency bandwidth in its subarea except frequency bandwidth used by the macro cell.

The semi frequency reuse scheme of the FIG. 9 and FIG. 10 can be also applied to a time resource reuse.

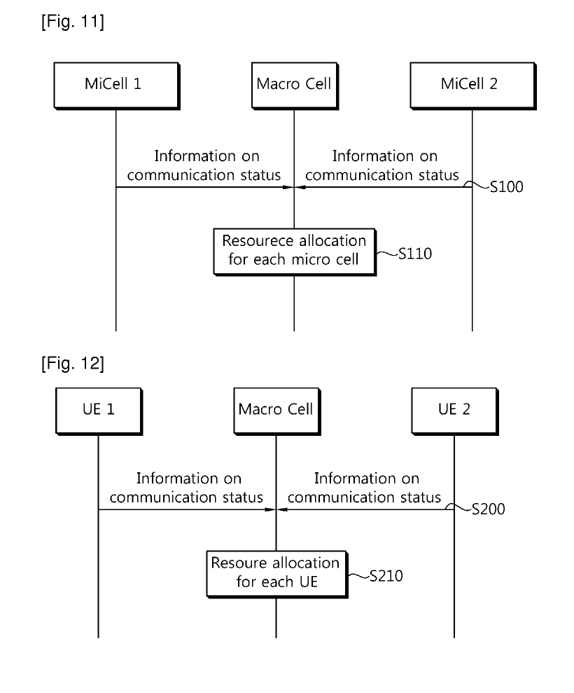

FIG. 11 is a flowchart showing a resource allocating method according to an embodiment of this invention. A micro cell may be located in coverage of a macro cell or adjacent to the macro cell. Coverage of the micro cell is smaller than the coverage of the macro cell. For explanation, a micro cell 1 (Micell 1) and a micro cell 2 (Micell 2) are exemplified, but this embodiment not limited thereto. One or more micro cells may exist for a macro cell.

Referring to FIG. 11, each of the micro cell 1 and the micro cell 2 transmits information on communication status of the micro cell to the macro cell (Step S100). The information on communication status of the micro cell may include at least one of information on the number of MSs managed in each micro cell, information on the required QoS (Quality of Service), information on the transmission rate, information on an amount of data in a buffer.

The macro cell allocates resource for each micro cell based on the information on communication status of the micro cell (step S110). The resource for each micro cell may be resource that each micro cell can use or cannot use. The resource may be time resource or frequency resource.

In addition, the macro cell may inform neighboring macro cells of the resource allocating result of the step S110. Accordingly, the neighboring macro cells can also allocate resource for each micro cell.

FIG. 12 is a flowchart showing a resource allocating method of a macro cell according to another embodiment of this invention. A micro cell may be located in coverage of a macro cell or adjacent to the macro cell. Coverage of the micro cell is smaller than the coverage of the macro cell. For explanation, a micro cell 1 (Micell 1) and a micro cell 2 (Micell 2) are exemplified, but this embodiment is not limited thereto. One or more micro cells may exist for a macro cell. It is assumed that a MS1 and a MS2 are connected to the macro cell.

Each of the MS1 and MS2 transmits information on communication status of the MS to the macro cell (Step S200). The information on communication status of the micro cell may be at least one of information on received power strength from the micro cell and information on path loss from the micro cell.

The macro cell allocates resource for the MS1 and the MS2 based on the information on communication status of the MS (Step S210). The macro cell can detect a location of each MS by using the information on communication status of the MS. Additionally, the macro cell may further consider the resource allocating result for the micro cell which is obtained through Step S100 and Step S110 of the FIG. 11 to allocate resource for the MS1 and the MS2.

According to one aspect of the aforementioned embodiment of the present invention (i.e., the frequency reuse scheme and the semi frequency reuse scheme), a frequency bandwidth used by an MS located in a boundary of two cells (i.e., a micro cell and a macro cell) having different cell coverage to transmit UL signals may vary over time. There is no particular restriction on a frequency bandwidth changing method. For example, a frequency bandwidth in use may be permutated or cycled over time. A channel state may not be good for a long period of time in a specific frequency bandwidth. In this case, if an MS located in a cell boundary is assigned with a frequency bandwidth of which a channel state is not good for a long period of time, the MS may not perform smooth communication for a long period of time. The frequency bandwidth may be changed to solve this problem.

The above embodiments exemplify that a resource reuse factor is high in UL transmission, and is low in DL transmission. It is also applied to a case that the resource reuse factor is high in DL transmission, and is low in UL transmission. For example, when each MS is assumed to be connected to a BS having the lowest path loss in order to optimize UL transmission, a communication quality may be worse because of weak signal strength from the micro cell. To solve this problem, it may be contemplated to allocate resources based on a location of each MS, and perform DL transmission by using the allocated resource.

Multi-Cell Cooperative (Coordinated) Communication

In the wireless communication system of FIG. 1 and FIG. 2, as an example of a method for managing radio resources according to an embodiment of the present invention, multi-cell cooperative communication may be asymmetrically performed for a UL and a DL. This will be described hereinafter in detail.

In the wireless communication system of FIG. 1 and FIG. 2, a signal received by the MS2 from the BS1 has a significantly small strength, and thus a cooperation gain may not be large even if cooperative communication is performed for the DL between the BS1 and the BS2. However, since a path loss of a UL signal from the MS2 is not much different in the BS1 and the BS2, a strength of UL received signal may be similar in each of the BS1 and the BS2. Accordingly, if cooperative communication between the BS1 and the BS2 is performed in the UL, that is, if a UL signal received by the BS1 is properly combined with a UL signal received by the BS2, a significantly large cooperation gain can be obtained.

On the other hand, in case of the MS1, a signal received from the BS1 has greater strength, and a signal received from the BS2 also has a strength above a specific value. Therefore, in this case, the MS1 can obtain a relatively high cooperation gain by performing cooperative communication for a DL signal. In a UL case, there is almost no cooperation gain since a path loss towards the BS2 is significantly large.

As such, in a wireless communication system based on the heterogeneous scenario, data processing efficiency can be improved when a specific MS performs multi-cell cooperative communication only in a UL and the remaining MSs perform multi-cell cooperative communication only in a DL. Therefore, in this case, it is preferable to selectively perform cooperative communication for the UL and the DL. By considering this, in an embodiment of the present invention, whether to perform cooperative communication is independently determined for the UL and the DL.

According to an embodiment of the present invention, a specific method for performing cooperative communication may differ in a DL and a UL. For example, the specific method for performing cooperative communication may differ according to information exchanged between BSs. In an asymmetric management scheme according to the embodiment of the present invention, information exchanged between BSs performing cooperative communication and a specific cooperative communication scheme according to the exchanged information may differ in the UL and the DL. In general, multi-cell cooperative communication can be classified into many types according to whether to-be-transmitted data is exchanged between BSs and/or whether channel information of neighboring cells is exchanged. Thus, the asymmetrical resource management scheme according to the embodiment of the present invention can be defined by different combining several types of cooperative communication schemes.

For example, according to one aspect of the present embodiment, regarding two neighboring cells each having different cell coverage, in the DL, data can be transmitted only from one BS without data exchange between the two cells, whereas in the UL, data can be received by both of the two BSs and the received data can be exchanged to combine a received signal with higher quality. According to another aspect of the present embodiment, in the DL, cooperative communication can be performed using a precoding matrix which has a less effect on interference to neighboring cells by exchanging channel information of the neighboring cells, whereas in the UL, cooperative communication can be performed by defining a combining matrix to obtain maximum signal quality after combining exchanged channel information and data.

Although the present invention has been particularly shown and described with reference to exemplary embodiments thereof, it will be understood by those skilled in the art that various changes in form and details may be made therein without departing from the spirit and scope of the invention as defined by the appended claims.

1. A method for managing radio resources in a wireless communication system, wherein
the wireless communication system is based on a heterogeneous cell deployment scenario,
a mobile station included in the wireless communication system establishes an uplink and a downlink with the same base station, and
a radio resource management scheme used for the uplink is different from a radio resource management scheme used for the downlink.

2. The method of claim 1, wherein the radio resource management scheme comprises a frequency reuse scheme.

3. The method of claim 2, wherein, in the frequency reuse scheme, a frequency reuse factor for the downlink uses a relatively low value, and a frequency reuse factor for the uplink uses a relatively high value.

4. The method of claim 3, wherein the wireless communication system comprises first and second neighboring cells each having different cell coverage, and a frequency used in the uplink by the first cell having smaller cell coverage than the second cell can be used in the uplink of a mobile station separated far from the first cell and belonging to the coverage of the second cell.

5. The method of claim 3, wherein the wireless communication system comprises at least one second cell having relatively small coverage inside or at a boundary region of the first cell having relatively large coverage, and a frequency for uplink transmission of the mobile station connected to a base station of the first cell is different in an interference area of the second cell and a non-interference area of the second cell.

6. The method of claim 5, wherein a frequency for uplink transmission of a mobile station located in the interference area of the second cell is different from the frequency for uplink transmission of the mobile station located in the coverage of the second cell, and a frequency for uplink transmission of a mobile station located in a non-interference area of the second cell is the same as the frequency for uplink transmission of the mobile station located in the coverage of the second cell.

7. The method of claim 5, wherein a frequency for uplink transmission of all or some of mobile stations connected to a base station managing the first cell is permutated or cycled over time.

8. The method of claim 1, wherein the radio resource management scheme comprises a multi-cell cooperative communication scheme.

9. The method of claim 8, wherein a downlink signal is transmitted from one base station, and an uplink signal is received by a plurality of base stations for multi-cell cooperation communication.

10. The method of claim 8, wherein a downlink signal is transmitted from a plurality of base stations performing multi-cell cooperation communication, and an uplink signal is received by only one base station.

11. The method of claim 8, wherein channel information on the downlink is not exchanged between base stations for multi-cell cooperation communication, and channel information on the uplink is exchanged between the base stations for multi-cell cooperation communication.

12. The method of claim 8, wherein channel information on the uplink is not exchanged between base stations for multi-cell cooperation communication, and channel information on the downlink is exchanged between the base stations for multi-cell cooperation communication.

13. The method of claim 8, wherein channel information on the uplink and channel information on the downlink are exchanged between base stations for multi-cell cooperation communication, and a type of the exchanged channel information on the uplink is different from a type of the exchange channel information on the downlink.

14. The method of claim 1, the radio resource is time resource or frequency resource.
